(19) United States
(12) Patent Application Publication
(10) Pub. No.: US 2009/0319185 A1
(43) Pub. Date: Dec. 24, 2009

(54) Navigation device with global position system and navigation method thereof

(75) Inventor: Shao-Yang Chiang, Hsinchu City (TW)

Correspondence Address: RABIN & Berdo, PC, 1101 14TH STREET, NW, SUITE 500, WASHINGTON, DC, 20005, US

(73) Assignee: NOVATEK MICROELECTRONICS CORP., Hsinchu (TW)

(21) Appl. No.: 12/232,581

(22) Filed: Sep. 19, 2008

(30) Foreign Application Priority Data
Jun. 23, 2008 (TW) 097123320

(51) Int. Cl. G01C 21/00

(52) U.S. Cl. 701/213

(57) ABSTRACT

A navigation device with a global position system (GPS) includes an information input module and a global position system module. The information input module includes an image fetching unit and an image recognition unit. The image fetching unit fetches a pattern of an external object to produce image data. The image recognition unit transfers the image data into input data. The global position system module receives location position data associated with a present location of the navigation device, and provides navigation information according to the location position data and the input data.

This application claims the benefit of Taiwan application Serial No. 97123320, filed Jun. 23, 2008, the subject matter of which is incorporated herein by reference.

### BACKGROUND OF THE INVENTION

1. Field of the Invention

The invention relates in general to a navigation device and a navigation method thereof, and more particularly to a navigation device with a global position system, and a navigation method thereof.

2. Description of the Related Art

In the modern age, in which the technology changes with each passing day, various electronic devices bring the extremely great convenient to the human's daily life. Taking a navigation device with a global position system (GPS) as an example, the navigation device receives a GPS signal transferred from a satellite and provides the navigation information under the user's operation.

Recently, the navigation device applying the GPS has become a necessary tool for the driver. Taking the GPS navigation device used in a vehicle as an example, when the user inputs the input data, a key of the device may be operated to input the address of the destination, and the GPS navigation device can program the navigation path according to the address and thus provide the reference for the user in driving the vehicle.

However, when the user is driving, and is concurrently operating the key of the GPS navigation device to input the associated data, he or she may encounter the inconvenience of driving the vehicle, and the danger may be caused by the distraction of the user. Thus, it is an important subject to design a GPS navigation device that can be operated conveniently.

### SUMMARY OF THE INVENTION

The invention is directed to a navigation device with a global position system, wherein the navigation device receives input data by way of image fetching so that the user can operate the navigation device more conveniently and it is possible to avoid the danger caused by the distraction of the user when the user is driving.

According to a first aspect of the present invention, a navigation device with a global position system (GPS) is provided. The navigation device includes an information input module and a global position system module. The information input module includes an image fetching unit and an image recognition unit. The image fetching unit fetches a pattern of an external object to produce image data. The image recognition unit transfers the image data into input data. The global position system module receives location position data associated with a present location of the navigation device, and provides navigation information according to the location position data and the input data.

According to a second aspect of the present invention, a navigation method applied to a navigation device with a global position system (GPS) is provided. The method includes the following steps. First, a pattern of an external object is fetched to produce image data. Next, the image data is transferred into input data. Then, location position data associated with a present location of the navigation device is received. Next, navigation information is provided according to the location position data and the input data.

The invention will become apparent from the following detailed description of the preferred but non-limiting embodiments. The following description is made with reference to the accompanying drawings.

### BRIEF DESCRIPTION OF THE DRAWINGS

FIG. 1 is a schematic illustration showing an external object and a navigation device with a global position system (GPS) according to an embodiment of the invention.

FIG. 2 is a schematic illustration showing an external object and a GPS navigation device according to a first embodiment of the invention.

FIG. 3 is a schematic illustration showing an external object and a GPS navigation device according to a second embodiment of the invention.

FIG. 4 is a schematic illustration showing an external object and a GPS navigation device according to a third embodiment of the invention.

FIG. 5 is a schematic illustration showing an external object and a GPS navigation device according to a fourth embodiment of the invention.

FIG. 6 is a flow chart showing a navigation method used in the GPS navigation device according to one embodiment of the invention.

### DETAILED DESCRIPTION OF THE INVENTION

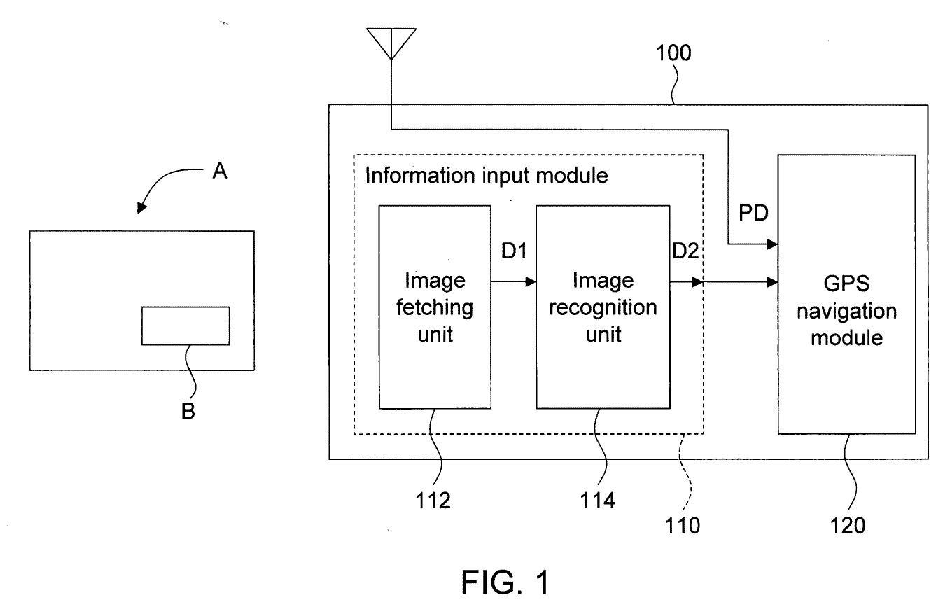

FIG. 1 is a schematic illustration showing an external object and a navigation device 100 with a global position system (GPS) according to an embodiment of the invention. Referring to FIG. 1, the GPS navigation device 100 includes an information input module 110 and a GPS module 120. The information input module 110 includes an image fetching unit 112 and an image recognition unit 114. The image fetching unit 112 fetches a pattern B of an external object A to produce image data D1. The image recognition unit 114 transfers the image data D1 into input data D2. The GPS module 120 receives location position data PD associated with a present location of the GPS navigation device 100, and provides navigation information according to the location position data PD and the input data D2. Several embodiments will be used to describe the GPS navigation devices and the navigation method thereof.

### First Embodiment

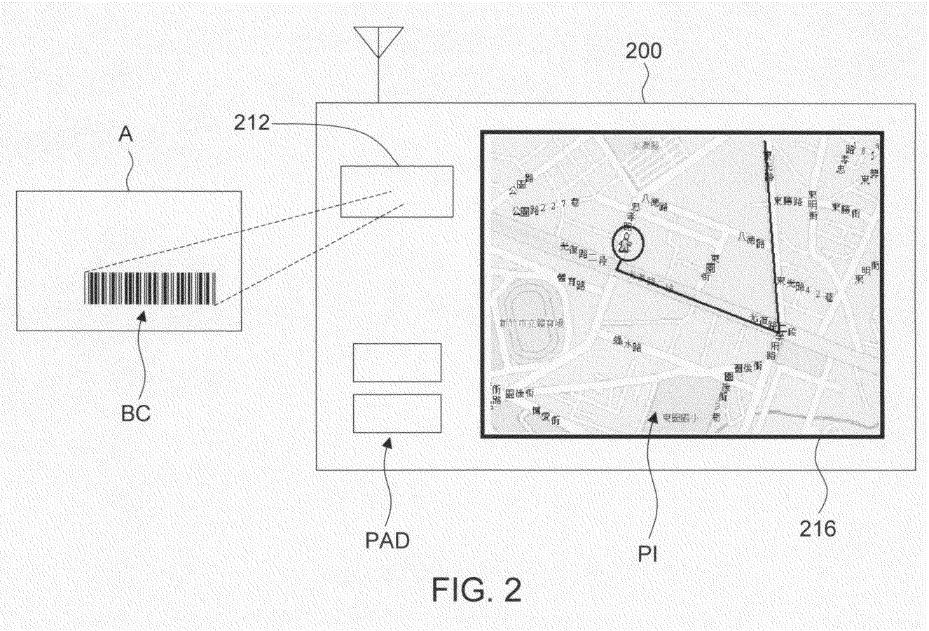

FIG. 2 is a schematic illustration showing an external object and a GPS navigation device 200 according to a first embodiment of the invention. Referring to FIGS. 1 and 2, an image fetching unit 112 of this embodiment is a bar code reader 212, and a pattern B of an external object A is a bar code BC. The image recognition unit 114 transfers the image data D1 into the input data D2 corresponding to the bar code BC. The input data D2 is destination position data corresponding to a destination. In this embodiment, the destination position data is the input data D2 that may be used in the GPS module 120.

How the bar code BC is transferred into the input data D2 that can be used in the GPS module 120 will be described in the following. The bar code BC usually represents the value information, such as the coordinate information. The coordinate information is encoded in a specific manner, for example, to form the patterned bar code BC. The bar code reader 212 reads the bar code BC and thus produces the image data D1 to be outputted to the image recognition unit 114.

The image recognition unit 114 decodes the image data D1 provided by the bar code reader 212, for example, so as to obtain the coordinate information represented by the bar code BC. Thus, the coordinate information is regarded as the destination position data of the destination and serves as the input data D2 to be transmitted to the GPS module 120.

Consequently, the GPS navigation device 200 can read the bar code BC (i.e., the above-mentioned destination position data) via the bar code reader 212 and transfer the bar code BC into the input data D2, which can be used in the GPS module 120, via the image recognition unit 114. After the GPS module 120 received the location position data PD associated with the present location of the GPS navigation device 200, the GPS module 120 provides navigation information PI according to the location position data PD and the input data D2 so that a display screen 216 displays the navigation information PI.

### Second Embodiment

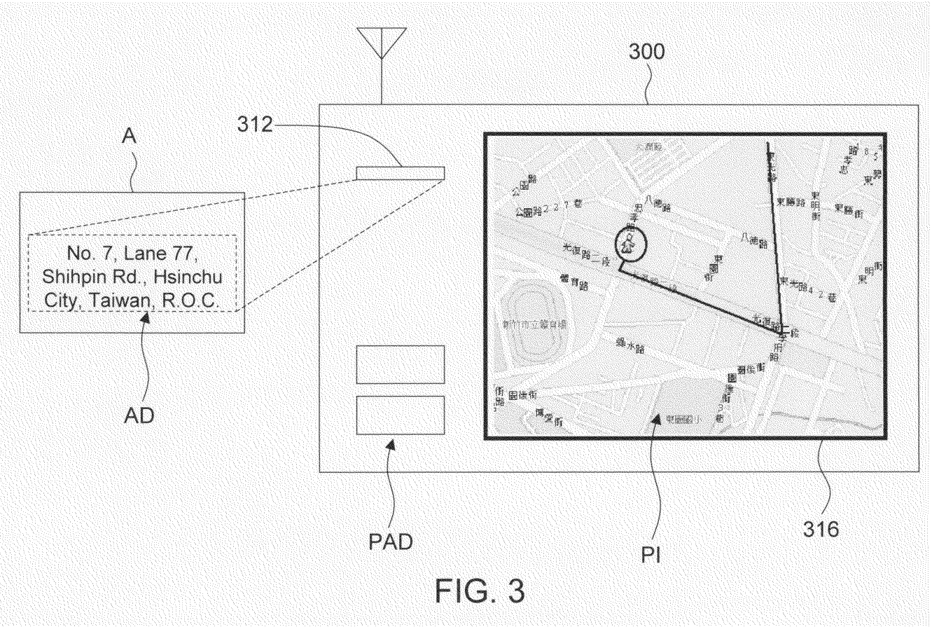

FIG. 3 is a schematic illustration showing an external object and a GPS navigation device 300 according to a second embodiment of the invention. Referring to FIGS. 1 and 3, the image fetching unit 112 of this embodiment is a scanning unit 312 for fetching the pattern by way of image scanning. The pattern B of the external object A is a text pattern. The image recognition unit 114 transfers the image data D1 into the input data D2 corresponding to the text pattern, and the input data D2 is string data corresponding to the destination. In this embodiment, the string data is the input data D2 that can be used in the GPS module 120.

How the bar code BC is transferred into the input data D2 that can be used in the GPS module 120 will be described in the following. In this embodiment, the pattern B of the external object A is the text pattern, which is one of an address pattern and a position coordinate pattern. In this embodiment, the address pattern AD will be illustrated. The address pattern AD represents address information, such as the text information “No. 7, Lane 77, Shihpin Rd., Hsinchu City, Taiwan, R.O.C.” shown in FIG. 3. The scanning unit 312 includes, for example, a linear sensor, for fetching the address pattern AD by way of linear scanning to produce the image data D1 to be outputted to the image recognition unit 114. In practice, the linear sensor is a charge couple device (CCD) having sensing cells arranged linearly.

The image recognition unit 114 recognizes the image data D1 provided by the linear sensor of the scanning unit 312 by way of character recognition to obtain the text information represented by the address pattern AD. Then, the image recognition unit 114 transfers the text information into the string data of the destination, and makes the string data as the input data D2.

Consequently, the GPS navigation device 300 of this embodiment can fetch the address pattern AD via the scanning unit 312, which includes the linear sensor, and transfer the address pattern AD into the input data D2, such as the above-mentioned string data which can be used in the GPS module 120, via the image recognition unit 114. After the GPS module 120 received the location position data PD associated with the present location of the GPS navigation device 300, the GPS module 120 provides the navigation information PI according to the location position data PD and the input data D2 so that a display screen 316 displays the navigation information PI.

### Third Embodiment

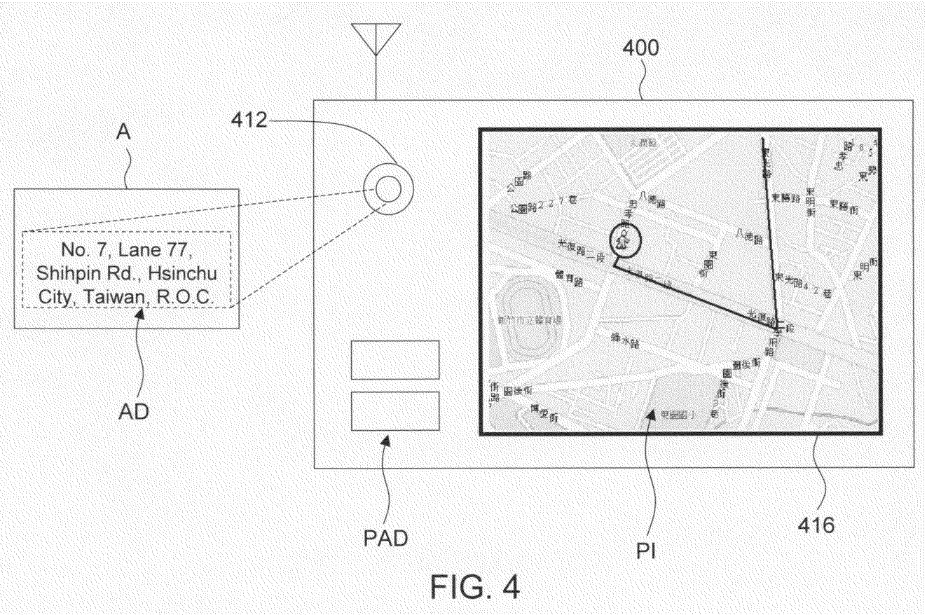

FIG. 4 is a schematic illustration showing an external object and a GPS navigation device 400 according to a third embodiment of the invention. As shown in FIGS. 1 and 4, what is different from the second embodiment is that a scanning unit 412 of the third embodiment includes a matrix sensor. The matrix sensor is a matrix CCD having sensing cells arranged in a matrix, and fetches the pattern by way of image sensing. Compared with the scanning unit 312 of the second embodiment, in which the address pattern AD is fetched by way of linear scanning, the scanning unit 412 of this embodiment uses the matrix CCD to directly fetch the completely two-dimensional address pattern AD by way of image sensing.

Consequently, the GPS navigation device 400 can fetch the address pattern AD via the scanning unit 412 including the matrix sensor, and transfer the address pattern AD into the input data D2, which can be used in the GPS module 120, via the image recognition unit 114. After the GPS module 120 received the location position data PD associated with the present location of the GPS navigation device 400, the GPS module 120 provides the navigation information PI according to the location position data PD and the input data D2 so that a display screen 416 displays the navigation information PI.

### Fourth Embodiment

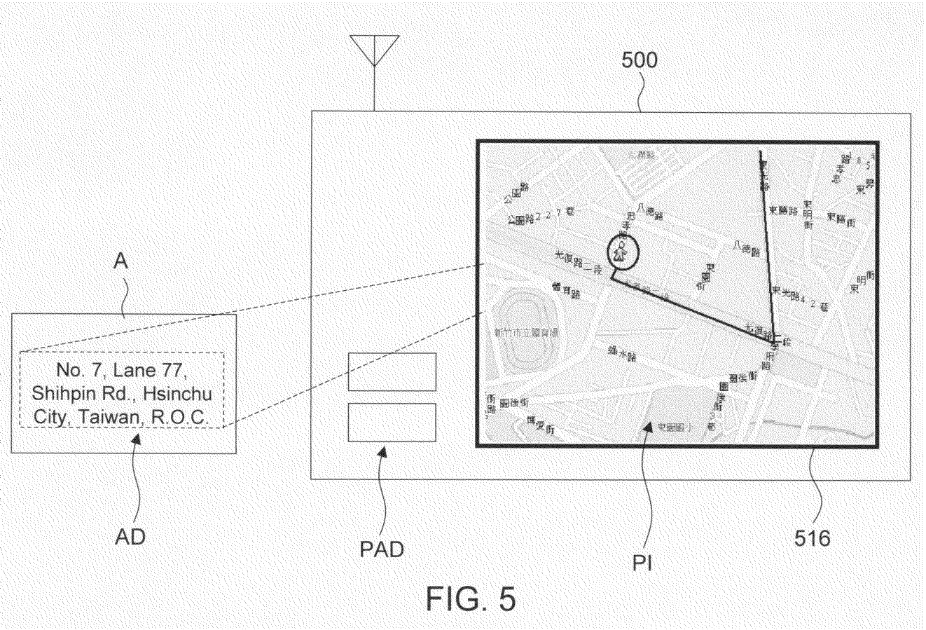

FIG. 5 is a schematic illustration showing an external object and a GPS navigation device 500 according to a fourth embodiment of the invention. As shown in FIGS. 1 and 5, what is different from the second embodiment is that the image fetching unit 112 is a display panel 516 having photosensitive pixels which fetches the pattern by way of image sensing, and displays the navigation information PI.

In this embodiment, the display panel 516 has two functions which are image sensing and image displaying. For example, PANASONIC Display Technology Corp. has disclosed the display panel having scan function in IDW'03 International display technology institute in FUKUOKA County of Japan. And, the associated technology is also researched by the famous SHARP Electronic Corp. of Japan. The display panel can display the image and fetch the image via the photosensitive pixels of the display panel. Thus, this embodiment can fetch the address pattern AD according to the scan function of this display panel.

Consequently, the GPS navigation device 500 can fetch the address pattern AD via the display panel 516 having the photosensitive pixels, and transfer the address pattern AD into the input data D2, which can be used in the GPS module 120, via the image recognition unit 114. After the GPS module 120 received the location position data PD associated with the present location of the GPS navigation device 500, the GPS module 120 provides the navigation information PI according to the location position data PD and the input data D2 so that the display panel 516 having the photosensitive pixels displays the navigation information PI.

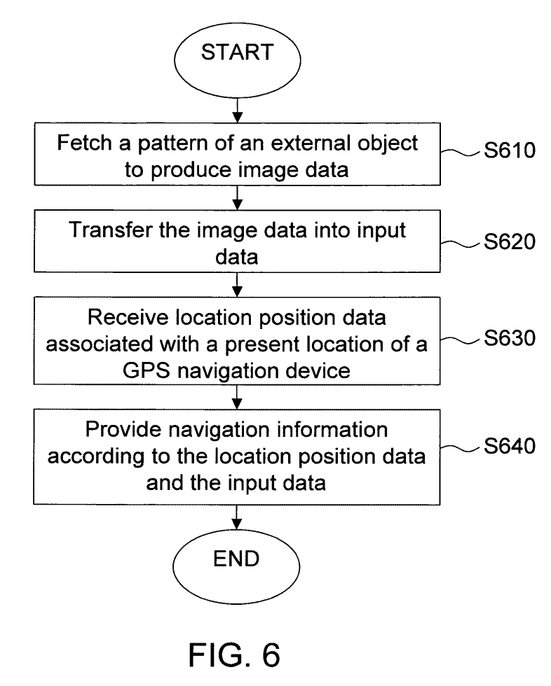

The invention further provides a navigation method. FIG. 6 is a flow chart showing a navigation method used in the GPS navigation device according to one embodiment of the invention. Referring to FIG. 6, the navigation method includes the following steps. In step S610, the pattern of the external object is fetched to produce the image data. In step S620, the image data is transferred into the input data. In step S630, the location position data associated with the GPS present location is received. In step S640, the navigation information is provided according to the location position data and the input data. The navigation method may be achieved using the GPS navigation device according to one of the first to fourth embodiments of the invention.

Compared with the conventional GPS navigation device, in which the key is adopted to provide the input data, the GPS navigation device according to each embodiment of the invention can enhance the convenience for the user. More particularly, it is more advantageous when the user is driving and wants to use the GPS navigation device. For example, the user has to pull the vehicle over to the side of the road, or has to stop the vehicle for the stop sign of the traffic light so that he or she can attentively operate the key or keys, such as the key pads PAD of FIGS. 2 to 5, on the conventional GPS navigation device so as to use the navigation information provided by the conventional GPS navigation device under the consideration of safety.

In comparison, when the GPS navigation device of each embodiment of the invention is used, the user only has to move the pattern of the external object, such as the address pattern of the business card, to approach the GPS navigation device when he or she is driving the vehicle and wants to use the GPS navigation device. Then, the GPS navigation device can fetch the address pattern by way of image fetching, and transfer the address pattern with the address information into the input data, which may be used by the GPS navigation device to generate the navigation information. Thus, the user does not have to stop the vehicle to perform the complicated inputting and setting operations via the key or the touch pen. Therefore, compared with the conventional GPS navigation device, the GPS navigation device according to each embodiment of the invention can enhance the convenience for the user.

The image fetching units are described by taking the bar code reader, the scanning unit and the display panel with the photosensitive pixels as examples. However, the invention is not limited thereto. Any image fetching unit still falls within the scope of the invention as long as it can provide the input data to the GPS navigation device by way of image fetching so that the GPS navigation device can provide the corresponding navigation information.

In the GPS navigation device and the navigation method thereof according to each embodiment of the invention, the input data is provided by way of fetching the image so that the user can conveniently operate the GPS navigation device to obtain the corresponding navigation information. In addition, the user can operate the navigation device more conveniently. So, the danger caused by the distraction of the user when the user is driving may be avoided. Consequently, using each GPS navigation device of the invention can enable the user to operate the GPS navigation device more conveniently and also can enhance the driving safety of the driver.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A navigation device with a global position system (GPS), the navigation device comprising:
an information input module, which comprises:
an image fetching unit for fetching a pattern of an external object to produce image data; and
an image recognition unit for transferring the image data into input data; and
a global position system module for receiving location position data associated with a present location of the navigation device, and providing navigation information according to the location position data and the input data.

2. The navigation device according to claim 1, wherein the image fetching unit is a bar code reader, the pattern of the external object is a bar code, and the input data is destination position data corresponding to a destination.

3. The navigation device according to claim 1, wherein the pattern of the external object is a text pattern, and the input data is string data corresponding to a destination.

4. The navigation device according to claim 3, wherein the text pattern is one of an address pattern and a position coordinate pattern.

5. The navigation device according to claim 1, wherein the image fetching unit is a scanning unit for fetching the pattern by way of image scanning.

6. The navigation device according to claim 1, wherein the image fetching unit comprises a charge couple device (CCD).

7. The navigation device according to claim 1, wherein the image fetching unit is a display panel with photosensitive pixels which fetches the pattern by way of image sensing, and displays the navigation information.

8. A navigation method applied to a navigation device with a global position system (GPS), the method comprising the steps of:
fetching a pattern of an external object to produce image data;
transferring the image data into input data;
receiving location position data associated with a present location of the navigation device; and
providing navigation information according to the location position data and the input data.

9. The method according to claim 8, wherein the step of fetching the pattern of the external object comprises:
fetching the pattern of the external object via a bar code reader to produce the image data, wherein:
the pattern of the external object is a bar code, and
the input data is destination position data corresponding to a destination.

10. The method according to claim 8, wherein the pattern of the external object is a text pattern, and the input data is string data corresponding to a destination.

11. The method according to claim 10, wherein the text pattern is one of an address pattern and a position coordinate pattern.

12. The method according to claim 8, wherein the step of fetching the pattern of the external object comprises:
fetching the pattern by way of image scanning.

13. The method according to claim 8, wherein the step of fetching the pattern of the external object comprises:
fetching the pattern by a charge couple device (CCD).

14. The method according to claim 8, wherein the step of fetching the pattern of the external object comprises:
fetching the pattern via a display panel having photosensitive pixels by way of image sensing, and displaying the navigation information.
